(19) United States
(12) Patent Application Publication
(10) Pub. No.: US 2025/0322344 A1
(43) Pub. Date: Oct. 16, 2025

(54) Determining method of a statistic fatigue level relative to a population of operators and associated determining system

(71) Applicant: THALES, Meudon (FR)

(72) Inventors: Florence DURIEUX, MERIGNAC (FR); Bastien BERTHELOT, MERIGNAC (FR); Vincent IBANEZ, MERIGNAC (FR)

(21) Appl. No.: 19/171,362

(22) Filed: Apr. 7, 2025

(30) Foreign Application Priority Data
Apr. 12, 2024 (FR) 2403807

(51) Int. Cl. G06Q 10/0639

(52) U.S. Cl. CPC G06Q 10/0639

(57) ABSTRACT

A method for determining a statistical fatigue level, including acquiring a plurality of operator assessment data determined from operator physiological data, acquiring a plurality of general context data, acquiring a plurality of particular context data, pre-processing all the data acquired, acquiring a time range for determining the level of statistical fatigue and acquiring a filter criterion, the filter criterion being based on the general context data and/or the particular context data, and determining, from the pre-processed data set, a statistical fatigue level according to the filter criterion acquired over the acquired time range.

### REFERENCE TO RELATED APPLICATION

This application is a U.S. non-provisional application claiming the benefit of French Patent Application No. 24 03807 filed on Apr. 12, 2024, the contents of which are incorporated herein by reference in their entirety.

### TECHNICAL FIELD OF THE INVENTION

The present invention relates to a method of determining a statistical fatigue level relative to a population of operators.

The present invention further relates to a determination system for implementing such a method.

The invention is in the technical field of operator fatigue assessment, particularly for the aeronautical industry. In this field, the invention makes it possible to improve flight safety.

However, the invention may still be used in all other fields where the management of operator fatigue is an important issue. These include areas where operational performance is required, such as transport, nuclear power, and medicine.

### BACKGROUND OF THE INVENTION

In the current prior art, operator fatigue is generally analyzed during temporary campaigns on the basis of questionnaires designed to capture subjective fatigue or on the basis of individual fatigue reporting.

There are also objective assessments based on biomathematical models, designed to raise specific, individual alerts when necessary.

These two ways of capturing fatigue only make it possible to deduce subjective fatigue, which may be biased by cultural or corporate pressure. In particular, operators reporting fatigue tend to underestimate it.

On the other hand, existing solutions do not provide objective, structural statistics that can be used to analyze fatigue according to defined criteria.

### SUMMARY OF THE INVENTION

The aim of the present invention is to provide a means of objectively assessing fatigue, while at the same time making it possible to synthesize the overall view of fatigue in order to plan operators' missions.

To this end, the invention relates to a method for determining a statistical fatigue level relative to a population of operators, including:
acquiring a plurality of operator assessment data determined from operator physiological data;
acquiring a plurality of general context data relating to the general assessment context of the operators;
acquiring a plurality of particular context data relating to the particular assessment context of the operators;
pre-processing all the data acquired;
acquiring a time range for determining the level of statistical fatigue and acquiring a filter criterion, the filter criterion being based on the general context data and/or the particular context data; and
determining, from the pre-processed data set, a statistical fatigue level according to the filter criterion acquired over the acquired time range.

In other beneficial aspects of the invention, the method includes one or more of the following features, taken in isolation or in combination in any technically possible combination:
transmitting the statistical fatigue level determined for display by a display interface;
validating the assessment data and the general context data according to one or more predetermined validation criteria;
the or each validation criterion is selected from the group including:
   the data acquired relates to a validated assessment;
   the data acquired relating to an identified operator;
   the data acquired complies with a minimum assessment period;
   the data acquired complies with a collection phase, each collection phase being chosen from an initial collection phase implemented before the mission, an intermediate collection phase implemented during the mission, and a final collection phase implemented after the mission;
the general context data includes at least one type of data selected
   from the group including:
   data relating to the operator's environment;
   physiological data of the operator;
the pre-processing of the general context data includes implementing at least one of the elements selected from the group
   including:
   defining the location of the assessment;
   defining the local time;
   identifying an early, normal or late shift;
   identifying the position occupied by the operator;
   extrapolating information about the operator's sleep;
the assessment data includes at least one type of data selected from the group consisting of:
   the operator's objective fatigue level; and
   the operator's subjective fatigue level;
the pre-processing of the assessment data includes implementing at least one of the elements selected from the group including:
   standardizing the objective fatigue level;
   standardizing the subjective fatigue level;
   identifying an objective fatigue class based on the objective fatigue level; and
   identifying a subjective fatigue class based on the subjective fatigue level;
the particular context data includes at least one type of data selected from the group including:
   data relating to the mission to be carried out by the operator;
   data relating to the mission(s) carried out by the operator; and
   operational data relating to activities carried out by the operator other than a mission; and
the pre-processing of the particular context data includes determining at least one of the elements selected from the group including:
   flight(s) operated;
   data specific to training sessions;
   time of day of the mission;
   type of aircraft;
   workload;
   degree of disruption to activity;
   activities in the days preceding the assessment;
   delays or disruptions during mission(s); and
   routes operated;
a step of correlating data acquired/determined during different collection phases relating to the same operator, each collection phase being chosen from an initial collection phase implemented before the mission, an intermediate collection phase implemented during the mission, and a final collection phase implemented after the mission;
advantageously, the correlation operation including the identification of the same operator identifier for at least two session identifiers associated with the acquired/determined data, corresponding to different collection phases.
determining a number of operators and/or a number of routes and/or a number of assessments corresponding to the acquired data that may be used to determine the statistical fatigue level according to this filter criterion; and
determining the statistical fatigue level further includes determining a confidence indicator associated with the determined statistical fatigue level, the confidence indicator being determined as a function of the number of operators and/or routes and/or assessments.

The invention also relates to a system for determining a statistical fatigue level relative to a population of operators, including technical means adapted to implement the method as defined above.

### BRIEF DESCRIPTION OF THE DRAWINGS

These features and advantages of the invention will be better understood upon reading the following description, given solely as a non-limiting example, and made in reference to the attached drawings, in which:

FIG. 1 is a schematic view of a determination system according to the invention;

FIG. 2 is a flowchart of a determination method according to the invention, the method being implemented by the system of FIG. 1; and

FIGS. 3-5 are schematic views illustrating the implementation of the method of FIG. 2.

### DETAILED DESCRIPTION OF THE INVENTION

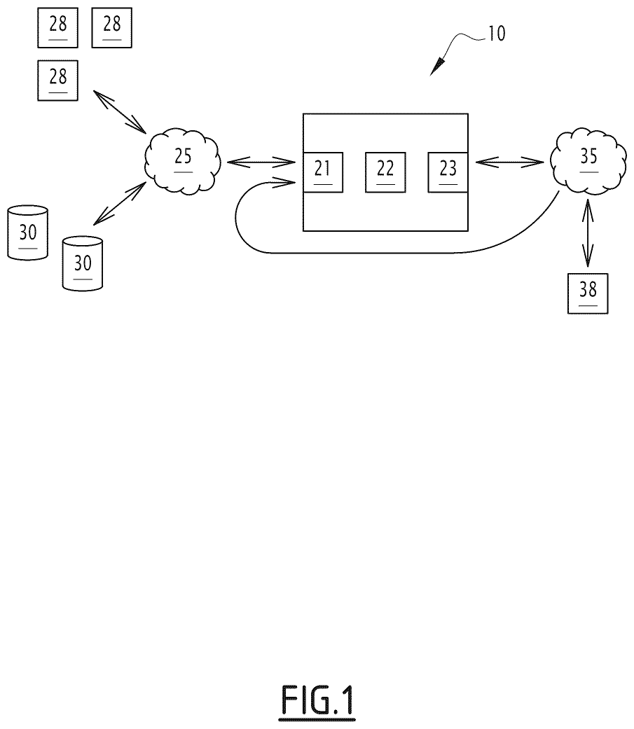

FIG. 1 shows a system 10 for determining a statistical fatigue level for a population of operators.

The population of operators includes more than two operators performing similar tasks on similar types of missions. For example, the population of operators includes a few dozen operators. In some examples, the population of operators includes several hundred or more. The population of operators may vary according to filtering criteria, which will be explained in more detail later.

Advantageously, the determination system 10 may be used in the aeronautical field. In this case, each operator is part of the flight crew, in particular the cabin crew. Other examples include flight planning operators, maintenance operators, aircraft control operators and air traffic controllers.

Advantageously, each operator is a pilot capable of flying an aircraft.

By “aircraft” we mean any flying machine that may be controlled from its cockpit, as in the case of an airplane or helicopter, or at a distance from it, as in the case of a drone.

Generally speaking, the notion of operator may apply to any other person carrying out a critical mission, for example in the transport sector (rail or heavy goods vehicles, for example) or in the nuclear or space sectors, or in medicine.

As mentioned above, each operator carries out a mission that is determined by the scope in which they operate.

In particular, the operator's mission includes a number of tasks defined based on the operator's skills.

When the operator is an aircraft pilot, his mission generally consists of piloting the aircraft from a point of departure to a point of destination.

With reference to FIG. 1, the determination system 10 includes an input module 21, a processing module 22 and an output module 23.

Each of these modules 21 to 23 is, for example, at least partially in the form of software and/or a programmable logic circuit such as an FPGA (Field Programmable Gate Array) circuit.

When these modules are at least partially in the form of software, the determination system 10 further includes a processor for implementing this software and a random access memory for at least temporarily storing the data to be processed or the data processed by these different modules. The determination system 10 may further include a non-volatile memory for storing at least some input data or output data, at least temporarily.

The input module 21 is configured to receive data from external systems.

In the example shown in FIG. 1, the external systems particularly include a plurality of transportable fatigue assessment systems 28 and one or more databases 30.

Each transportable fatigue assessment system 28 may generate a plurality of assessment data relating to the fatigue of different operators.

In particular, each of the transportable assessment systems 28 may generate operator assessment data from the physiological data of these operators.

The physiological data of the operator includes any type of data that may be used to characterize the operator's physical state. This physiological data is advantageously acquired just before the mission during an initial collection phase, or during the mission during an intermediate collection phase, or just after the mission during a final collection phase.

Advantageously, the physiological data of the operator include at least one type of data selected from the group including:
images or videos of the operator;
heart rate;
blood pressure;
oxygen intake;
breathing rate;
breathing amplitude;
sweating;
oxygen saturation; and
dehydration level.

To acquire physiological data, each transportable assessment system 28 includes a plurality of sensors. Alternatively or advantageously, each transportable assessment system 28 is connected directly or indirectly to a plurality of sensors located, for example, in the operator's workstation. For example, these sensors are fixed and/or removable in the cockpit of the aircraft flown by the operator.

In particular, the plurality of sensors includes any sensor for acquiring the physiological data of the operator.

For example, the plurality of sensors includes a camera configured to acquire images of the operator and a heart rate sensor for measuring the operator's heart rate.

For example, the camera is oriented towards the operator or has means for orienting it depending on the operator's position.

The operator heart rate sensor is configured, for example, to be positioned around the operator's wrist.

To this end, the heart rate sensor has, for example, a connected watch or bracelet that may be attached to the operator's wrist and a sensitive part that is designed to measure the operator's heart rate when the bracelet is attached to his wrist.

The heart rate is measured, for example, by the sensitive part, using a technique known as photoplethysmography, or PPG. Alternatively, the sensitive part is configured to perform the heart rate measurement from an analysis of electrical response by the operator's wrist or by analysis of radar signals propagating within the operator's wrist.

In some examples, the heart rate sensor is configured to measure other physiological parameters of the operator such as (non-exhaustive list) arterial pressure, oxygen intake, breathing rate, breathing amplitude, sweating and dehydration rate.

For oxygen saturation, the heart rate sensor is configured, for example, to emit towards the operator's skin and receive a light signal including at least two wavelengths. A first wavelength corresponding to a wavelength absorbed by saturated red blood cells, a second wavelength corresponding to a wavelength absorbed by unsaturated red blood cells. To determine oxygen saturation, the heart rate sensor is then configured to compare the light intensity received in response to each of the two wavelengths.

Generally speaking, the heart rate sensor may take the form of a connected watch to measure one's heart rate, for example.

Of course, the aforementioned heart rate sensor functionalities may form separate sensors.

The assessment data transmitted by the transportable assessment systems 28 advantageously include objective fatigue levels of operators who have used these systems 28.

Preferably, this assessment data further include subjective fatigue levels of these operators.

In particular, each objective fatigue level is determined at least in part by the transportable assessment system 28 on the basis of the physiological data of the operator and possibly on the basis of context data. In some examples, the objective fatigue levels are determined by one or more systems remote from the transportable assessment systems 28, for example on the basis of the operators' physiological data transmitted by these systems 28. This remote system or systems may form servers.

Each operator's subjective fatigue level is entered by the operator himself via, for example, an interface on the corresponding transportable assessment system 28.

Advantageously, the transportable systems 28 are also able to provide general context data relating to the general assessment context of the operators.

These general context data include at least one type of data selected from the group including:
data relating to the operator's environment; and
physiological data of the operator.

Data relating to the operator's environment are, for example, data describing the environment in which the operator's assessment was carried out.

The physiological data of the operator relates to the operator himself and include, for example, data determined by the various sensors as explained above.

In some cases, this physiological data further include physiological data entered by the operator via the communication interface of the corresponding transportable assessment system 28. This data is entered by the operator, for example, following various questions relating to his general physiological state, such as how long he sleeps, how much he naps, the hours when he is at rest, etc.

The general context data is linked, for example, to the assessment data transmitted by the corresponding transportable assessment system 28 by a unique session identifier.

In other words, this unique session identifier makes it possible to associate the assessment data determined by this system 28 with the general context data which corresponds to this assessment data.

This unique session identifier may, for example, be associated with an identifier for the operator whose assessment data is being used. To do this, the general context data may include the identifier of this operator. The operator's identifier may be anonymized.

The database(s) 30 may be used to provide particular context data. These particular context data include at least one type of data selected from the group including:
data relating to the mission to be carried out by the operator;
data relating to the mission(s) carried out by the operator; and
operational data relating to activities carried out by the operator other than a mission.

This particular context data corresponds, for example, to the flight planning carried out or to be carried out by different operators.

Data on non-mission activities carried out by operators include, for example, data on their physical activities. This data is taken, for example, from the operator's sports monitoring application or from any other organization that deals with operators' activities.

The activities carried out by the operator may further include, for example, in-flight or ground activities such as training, on-call duty, illness, etc.

The database(s) 30 may then belong to the airline or any other third party organization that stores the particular context data as defined above.

The processing module 22 is used to process the data acquired by the input module 21, as will be explained in more detail later.

The processing module 22 may also generate output data which are transmitted to the output module 23.

The output module 23 is used to send the data generated by the processing module 22 to any external system involved. This external system is connected, for example, to this output module 23 via a global or local computer network 35.

In the example shown in FIG. 1, such an external system includes, for example, a communication interface 38 with a user such as a manager (i.e., a Safety Manager) or any other superior of the operators.

This communication interface 38 includes, for example, a display means such as a screen and an input means.

This input means enables the user, for example, to enter a display criterion which may also be transmitted to the input module 21 to be taken into account in the output data transmitted by the output module 23.

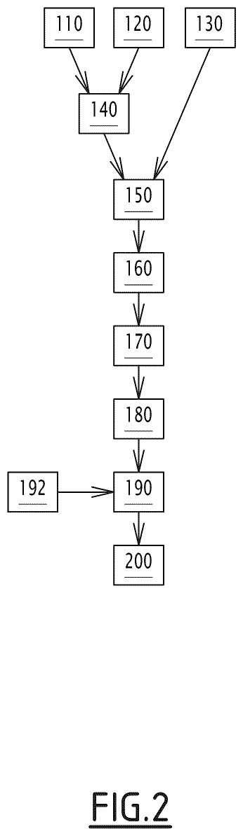

The determination system 10 enables a fatigue level determination method 10 to be implemented and will now be described with reference to FIG. 2, which shows a flowchart of its steps.

It is initially assumed that the transportable assessment systems 28 have generated physiological data relating to a population of operators. This physiological data is used by the transportable systems 28 and/or other remote systems to generate assessment data.

The assessment data include the objective/subjective fatigue levels of these operators.

Advantageously, the assessment data have been generated following one or more collection phases.

As previously indicated, each collection phase is chosen from an initial collection phase implemented before the mission, an intermediate collection phase implemented during the mission, and a final collection phase implemented after the mission.

The initial collection phase, also known as check-in, involves acquiring physiological data and mission data relating to the corresponding operator and generating an objective fatigue level from this data.

The intermediate collection phase, also known as on-duty, involves collecting different types of data, such as the physiological data of the operator and data relating to the current mission. This collection, for example, is carried out by a device remote from the transportable assessment device. Such a remote device may include a connected watch or any other mobile device worn by the operator during the mission.

The final collection phase, also known as the check-out phase, includes the collection of data generated during the mission as well as the physiological data of the operator acquired by the transportable assessment system 28 following the mission.

In some embodiments, the intermediate collection phase is optional. In this case, only the initial and final collection phases are carried out.

It is also assumed that initially the transportable assessment systems 28 generate the general context data associated with the operator assessment data. This general context data is linked, for example, to the corresponding operator assessment data by a unique session identifier as defined above.

Finally, it is also assumed that the database(s) 30 contain the particular context data relating to the particular context in which the operators are assessed.

During steps 110, 120, 130 the input module 21 respectively acquires the assessment data from the transportable assessment systems 28, the general context data also from these transportable assessment systems 28 and the particular context data from the database(s) 30.

These steps 110, 120, 130 may be implemented by the input module 21 in parallel. Alternatively, at least some of these steps are carried out consecutively.

At the end of these steps, the input module 21 transmits the acquired data to the processing module 22.

In the next step 140, the processing module 22 validates the assessment data and the general context data by applying one or more predetermined validation criteria.

These validation criteria are predetermined, for example, based on the nature of the data whose validity is being studied. The or each validation criterion is selected from the group including:
acquired data relating to a validated assessment (i.e., the assessment is validated by the transportable assessment device 28 which has collected the corresponding data);
acquired data relating to an identified operator (i.e., the operator has been identified by the transportable assessment system 28 that transmitted the corresponding data and a possibly anonymized identifier is associated with the operator);
acquired data which complies with a minimum duration of the assessment (the minimum duration of the assessment may be set by the transportable assessment system which has transmitted the corresponding data and may include, for example, a few minutes), associated with these data; and
acquired data which complies with a collection phase.

In particular, with regard to compliance with the collection phase, the processing module 22 checks that the data received corresponds to that to be collected/generated during the corresponding collection phase.

To do this, the processing module 22 may, for example, check that the types of data transmitted correspond to those expected based on the corresponding collection phase.

The minimum assessment period may also depend on the corresponding collection phase.

For example, this time may be shorter for the initial collection phase than for the final collection phase.

If the acquired data is not validated according to one of the aforementioned criteria, the processing module 22 rejects this data from future consideration, for example.

In the next operation 150, the processing module 22 pre-processes all the acquired data. Pre-processing is chosen according to the nature of the acquired data, for example.

Thus, for example, the pre-processing of the general context data includes implementing at least one of the elements selected from the group including:
defining the location of the assessment (e.g., from the configuration or from the geographical coordinates of the assessment);
defining the local time (calculated, for example, based on the location of the assessment);
identifying an early, normal or late shift;
identifying the position occupied by the operator during his mission (e.g., pilot or co-pilot when the operator's mission is a flight); and
extrapolating information relating to the operator's sleep (e.g., sleep duration, bed/rise times, nap duration, chronotype, etc.).

In particular, with regard to the identification of the morning, normal or late session, morning or late flights are defined by the regulations (e.g., ORO.FTL.105, (i) and ARO.OPS.230). For the sessions, we add a margin of two hours before the flight departs (since the pilot arrives well before the flight) and one hour after the flight arrives. As a result, the morning time slot is between 03:00 and 05:59, for example, and the late time slot is between 23:00 and 02:59 local time at the operator's location.

The pre-processing of the assessment data includes, for example, implementing at least one of the elements selected from the group including:
standardizing the fatigue level (e.g., on the KSS (Karolinska Sleepiness Scale) ranging from 1 to 9);
standardizing the subjective fatigue level (e.g., using the same KSS scale);
identifying an objective fatigue class based on the objective fatigue level; and
identifying a subjective fatigue class based on the subjective fatigue level (using, for example, the same classes as for the objective fatigue level).

The classifying of the fatigue level into different classes may be carried out, for example, according to the value of the objective or subjective fatigue level. The number of classes, for example, has a predetermined value which may be chosen between 2 and 10. Thus, for example, it is possible to choose just two classes of fatigue (satisfactory and unsatisfactory) or three classes of fatigue (intermediate, high, very high).

To this end, the processing module 22 may, for example, compare the objective subjective fatigue level determined and possibly standardized with predetermined thresholds.

The pre-processing of the particular context data includes, for instance, determining at least one of the elements selected from the group including:
the flight operated (flight identifier, departure airport, arrival airport);
data specific to training sessions (type of mission, duration of flight, landing time, night flight);
the period of the day of the assignment (the exact times and duration of the assignment);
the type of aircraft or other instruments/equipment used during the mission;
the workload (e.g., the degree of disruption during the mission);
activities in the days preceding the assessment;
delay or disruption during the mission; and
the routes operated.

Some of this data may be extracted or deduced from databases as defined above.

For example, the type of aircraft may be extracted from data on planned or operated commercial flights.

Delays or disruptions may be extracted from data on commercial flights and weather data relating to these flights.

The flights operated may be extracted from the crew schedule associated with the corresponding operator.

Some of these data may be used to construct more elaborate data, such as:
the routes operated, which may be derived from an analysis of the commercial flights operated; and
delays in effect, which may be derived from an analysis of data on scheduled and actual commercial flights.

In the next operation 160, the processing module 22 correlates the data acquired/determined during different collection phases relating to the same operator.

For example, in some cases there is data that is acquired or determined only during the initial collection phase and other data that is acquired/determined only during the final collection phase.

In this case, the processing module 22 will associate these data using the unique session identifier associated with each type of data and the operator identifier. For example, when the processing module 22 identifies the same operator identifier for two unique session identifiers corresponding respectively to an initial collection phase and a final collection phase, it may correlate the data collected during these different phases.

The same applies to the intermediate collection phase.

In addition, it is possible to correlate data from a plurality of initial collection phases and a plurality of final collection phases relating to the same operator.

In the next step 170, the input module 21 acquires a time range for determining the fatigue level and a filter criterion.

This data is acquired by the input module 21 following the user's interaction with the interface 38.

This interaction is carried out, for example, following authentication of the user via the interface 38 and transmission of this data to the input module 21 via the network 35.

The default time range covers all sessions, for example. Advantageously, the user may select a sub-range from this range covering all sessions, which will then be transmitted to the input module 21. This range may, for example, include specific dates or a predefined period (previous week, previous month, previous quarter, previous half-year, previous year, etc.).

The filter criterion is based, for example, on general context data and/or particular context data.

This filter criterion may include simple filtering (for example by mission type or aircraft type) or compound filtering (i.e., a plurality of superimposed filters such as operator age and aircraft type).

At the end of this step 170, the input module 21 transmits all the acquired data to the processing module 22.

In the next step 190, the processing module 22 uses the set of pre-processed data to determine a statistical fatigue level according to the filter criterion acquired over the acquired time range.

This statistical fatigue level may then be presented in the form of a graph or diagram varying along the time range or representing different values as a function of the filter criterion.

According to some embodiments, the method may further include a step 192 which includes determining a number of operators and/or a number of routes and/or a number of assessments corresponding to the acquired data which may be used to determine the statistical fatigue level according to the chosen filter criterion.

In other words, during this step, the processing module 22 analyses the usability of the acquired data for the corresponding filter criterion and then deduces a number representative of these usable data.

This representative number may then designate the number of operators who have been assessed to acquire this data or the number of routes carried out by these operators or the number of assessments generated by these operators by the transportable assessment systems 28.

In some embodiments, the processing module 22 may also determine a confidence indicator associated with the statistical fatigue level determined as a function of the number of operators and/or routes and/or assessments.

Finally, in step 200, the output module 23 transmits the statistic level determined, together with any associated confidence indicator, to the interface 38 for display in an appropriate form.

This appropriate form may be chosen by the user depending, for example, on the nature of the filter criterion.

Some examples of application of the method according to the invention as a function of different filtering criteria will be described below.

According to a first example of application of the method, the filter criterion consists of filtering the objective/subjective statistical fatigue level after the initial collection phase (check-in) and after the final collection phase (check-out).

In such an example, the processing module 22 calculates the following values in operations 190 and 192 described above:
the number of sessions: this is the number of sessions over the time period acquired;
the number of operators: this is the number of different operators who have carried out sessions over the time period acquired;
the number of routes: this is the number of different routes operated during sessions over the time period acquired. This is, for example, an optional parameter calculated during the operations;
objective fatigue levels during the initial collection phase (check-in): the fatigue levels calculated by the transportable assessment systems 28 are for example classified into a plurality of classes (for example into three classes as defined above);
objective fatigue levels during the final collection phase (check-out): similarly, this involves classifying the calculated objective fatigue levels into a plurality of classes (three classes, for example);
subjective fatigue levels during the initial collection phase (check-in): same, classification into a plurality of classes (e.g., three classes); and
subjective fatigue levels during the final assessment phase (check-out): as here, classification into a plurality of classes (e.g., three classes).

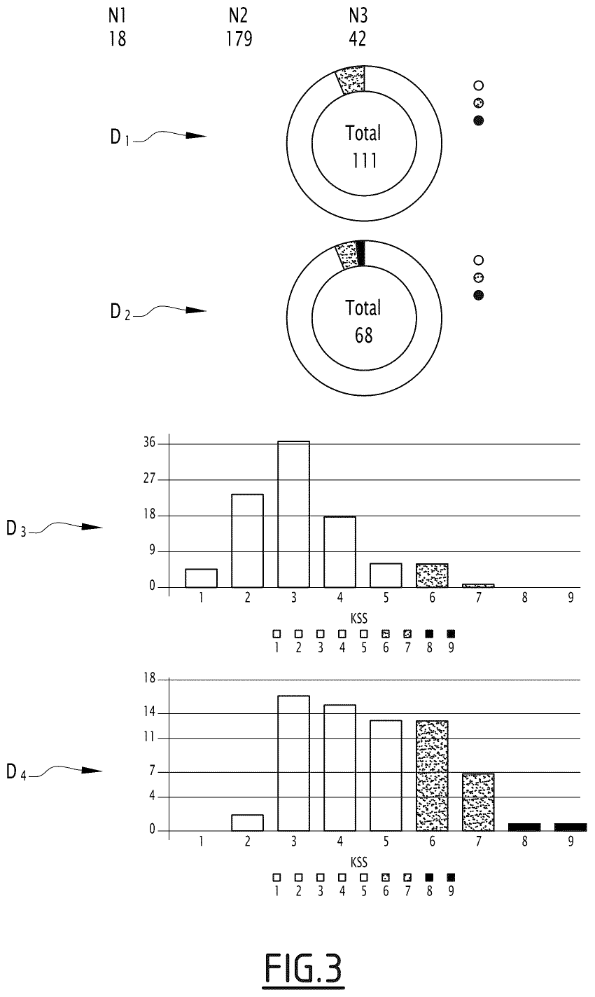

FIG. 3 illustrates an example of the display obtained following the implementation of this example.

Thus, as shown in FIG. 3, the display first includes the display of three values N1, N2 and N3 which correspond respectively to the number of operators, the number of sessions and the number of routes calculated by the processing module 22.

The display further includes four diagrams D1, D2, D3 and D4. Diagram D1 shows the classification of operators' statistical objective fatigue level during the initial check-in phase.

Diagram D2 shows the classification of the statistical objective fatigue level during the final collection phase (check-out).

Diagram D3 shows the classification of the statistical subjective fatigue level of operators during the initial collection phase (check-in).

Finally diagram D4 shows the classification of the subjective fatigue level during the final collection phase (check-out).

As shown in FIG. 3, the shape and type of diagram may vary depending on the filter criterion chosen.

Users may also choose the type of diagram they want.

Finally, it is also possible to apply an additional filter criterion to diagrams already displayed.

For example, it is possible to refine these values by aircraft type, by operator role during the mission, by mission type, etc.

According to a second application example, the filter criterion may also include the classification of the level of statistical fatigue during the operators' mission.

To do this, the processing module 22 may, for example, divide the mission into a plurality of sections and then determine the statistical fatigue level for each of the sections.

So, for example, when the operator is a pilot or co-pilot, it is possible to divide the mission (i.e., flight) into three sections of identical length, or into sections based on characteristic points in the mission, such as the end of climb, cruise, after the start of descent.

In this case, the information on the fatigue level in each of the sections presents an average value of the fatigue level calculated continuously in these sections.

In a third example, the statistical fatigue level is calculated for different categories of operator.

These categories are determined, for example, by the gender of the operator, the operator's function during the assignment, the operator's age bracket, etc.

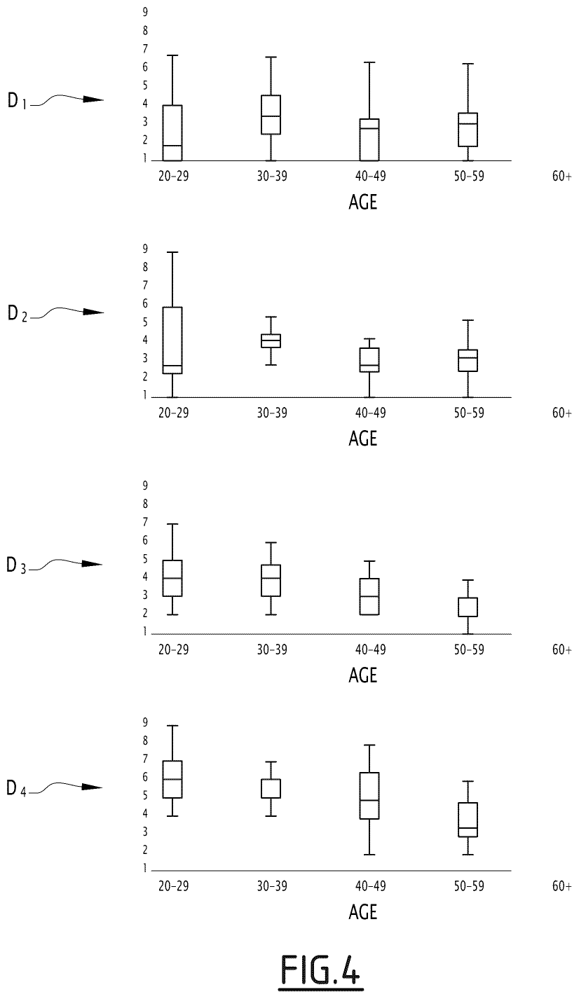

FIG. 4 shows an example of such a display for different operator categories.

In this example, the operator categories are formed by age bracket.

So, for example, the processing module 22 in this case calculates five categories of operator per age bracket. These categories include a first bracket for ages 20 to 29, a second bracket for ages 30 to 39, a third bracket for ages 40 to 49, a fourth bracket for ages 50 to 59, and a fifth bracket for ages over 60.

In addition, different categories may be calculated for different types of fatigue level and for different collection phases.

FIG. 4 shows the diagrams D1 to D4 calculated for these age brackets.

Diagram D1 corresponds to the objective statistical fatigue level calculated per age bracket in the initial assessment phase, diagram D2 corresponds to the objective statistical fatigue level per age bracket calculated in the final assessment phase, diagram D3 corresponds to the subjective statistical fatigue level per age bracket calculated in the initial collection phase and diagram D4 corresponds to the subjective collection fatigue level per age bracket calculated during the final collection phase.

Each of these diagrams includes on the horizontal axis the corresponding age bracket and on the vertical axis the corresponding level of statistical fatigue calculated on a scale varying, for example, from 1 to 9.

In a fourth example of application, the statistical fatigue level is calculated by mission category.

Such an assignment category may, for example, include the number of consecutive mission days.

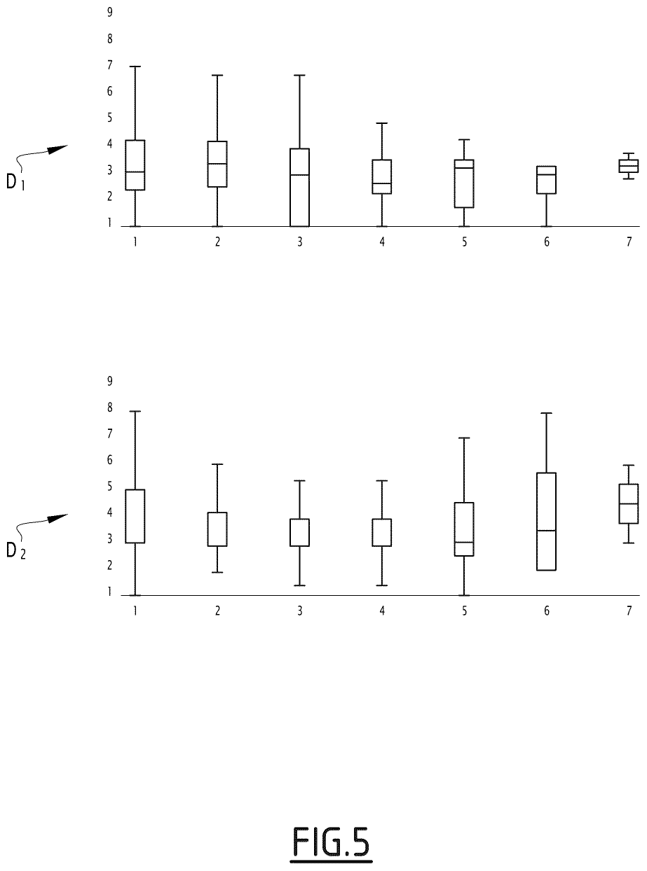

FIG. 5 shows an example of such a statistical fatigue level.

In this example, the categorization is based on eight categories corresponding to the number of consecutive mission days.

FIG. 5 shows diagrams D1 and D2 corresponding respectively to the statistical objective fatigue level and the statistical subjective fatigue level as a function of the number of consecutive mission days.

Of course, many other examples of filter criteria and the superposition of different filters are also possible.

It is therefore clear this present invention has a number of advantages.

Firstly, the proposed solution consists of implementing a method that enables objective or subjective fatigue to be represented statistically over a period of time, from different points of view.

The solution makes it possible to present fatigue by focusing on certain points of context captured during the assessments.

The proposed solution has the advantage of being based on an objective or subjective state of fatigue that is contextualized and required for a population over a wide time span, rather than on a subjective or one-off state of fatigue that is often disconnected from its context.

In this way, the invention provides a global overview of the statistical fatigue of operators, enabling missions to be planned in such a way as to effectively take into account this fatigue.

1. A method for determining a statistical fatigue level relative to a population of operators, comprising:
acquiring a plurality of operators' assessment data determined from operators' physiological data;
acquiring a plurality of general context data relating to the general assessment context of the operators;
acquiring a plurality of particular context data relating to the particular assessment context of the operators;
pre-processing the operators' assessment data, the general context data, and the particular context data;
acquiring a time range for determining the level of statistical fatigue;
acquiring a filter criterion, the filter criterion being based on the general context data or the particular context data; and
determining, from the pre-processed data set, a statistical fatigue level according to the filter criterion acquired over the acquired time range.

2. The method according to claim 1, wherein the filter criterion is based on the general context data and the particular context data.

3. The method according to claim 1, further comprising transmitting the determined statistical fatigue level for display by a display interface.

4. The method according to claim 1, further comprising validating the assessment data and the general context data according to one or more predetermined validation criteria.

5. The method according to claim 4, wherein the or each validation criterion is selected from the group comprising:
the data acquired relates to a validated assessment;
the data acquired relating to an identified operator;
the data acquired complies with a minimum assessment period; and
the data acquired complies with a collection phase, each collection phase being chosen from an initial collection phase implemented before the mission, an intermediate collection phase implemented during the mission, and a final collection phase implemented after the mission.

6. The method according to claim 1, wherein the general context data comprises at least one type of data selected from the group consisting of:
data relating to the operator's environment; and
physiological data of the operator.

7. The method according to claim 6, wherein said pre-processing the general context data comprises implementing at least one element selected from the group consisting of:
defining the location of the assessment;
defining the local time;
identifying an early, normal or late shift;
identifying the position occupied by the operator; and
extrapolating information about the operator's sleep.

8. The method according to claim 1, wherein the assessment data comprises at least one type of data selected from the group comprising:
the operator's objective fatigue level; and
the operator's subjective fatigue level.

9. The method according to claim 8, wherein said pre-processing the assessment data comprises implementing at least one selected from the group consisting of:
standardizing the objective fatigue level;
standardizing the subjective fatigue level;
identifying an objective fatigue class based on the objective fatigue level; and
identifying a subjective fatigue class based on the subjective fatigue level.

10. The method according to claim 1, wherein the particular context data comprises at least one type of data selected from the group comprising:
data relating to the mission to be carried out by the operator;
data relating to the mission(s) carried out by the operator; and
operational data relating to activities carried out by the operator other than a mission.

11. The method according to claim 10, wherein said pre-processing of the particular context data comprises determining at least one selected from the group consisting of:
flight(s) operated;
data specific to training sessions;
time of day of the mission;
type of aircraft;
workload;
degree of disruption to activity;
activities in the days preceding the assessment;
delays or disruptions during mission(s); and
routes operated.

12. The method according to claim 1, further comprising correlating data acquired/determined during different collection phases relating to the same operator, each collection phase being chosen from an initial collection phase implemented before the mission, an intermediate collection phase implemented during the mission, and a final collection phase implemented after the mission.

13. The method according to claim 12, wherein said correlating comprises identifying the same operator identifier for at least two session identifiers associated with the acquired/determined data, corresponding to different collection phases.

14. The method according to claim 1, further comprising, for the acquired filter criterion, determining a number of operators and/or a number of routes and/or a number of assessments corresponding to the acquired data, the acquired data being used to determine the statistical fatigue level according to this filter criterion.

15. The method according to claim 14, wherein said determining the statistical fatigue level further comprises determining a confidence indicator associated with the determined statistical fatigue level, the confidence indicator being determined as a function of the number of operators and/or routes and/or assessments.
